(19) United States
(12) Patent Application Publication
(10) Pub. No.: US 2002/0191319 A1
(43) Pub. Date: Dec. 19, 2002

(54) Merged defect entries for defects running in circumferential and radial directions on a disc

(75) Inventors: San Yuan Liew, Signapore (SG); Teck Khoon Lim, Singapore (SG); Kok Hoe Chia, Singapore (SG)

Correspondence Address: Merchant & Gould P.C., P.O. Box 2903, Minneapolis, MN, 55402-0903, US

(73) Assignee: Seagate Technology LLC

(21) Appl. No.: 10/003,459

(22) Filed: Oct. 31, 2001

Related U.S. Application Data
(60) Provisional application No. 60/283,493, filed on Apr. 12, 2001.

(51) Int. Cl. G11B 5/09

(52) U.S. Cl. 360/53

(57) ABSTRACT

A method of, system, modules, and computer readable media for generating a defect error log on a disc in a disc drive is disclosed. All defective sector addresses of all defective sectors on the disc are identified and stored in the memory. At least two defective sectors identified are adjacent to each other circumferentially or radially or in both directions. The at least two sector addresses of adjacent defective sectors are merged into a defect error entry. Merging refers to a conversion (or encoding) of the multi sector addresses into a defect error entry. The converted defect error entry is then stored in the defect error log.

### RELATED APPLICATIONS

This application claims priority of United States provisional application Serial No. 60/283,493, filed on Apr. 12, 2001 and titled “ENHANCE LOG ANALYSIS WITH MERGE OF RADIAL AND CIRCUMFERENTIAL DEFECT.”

### FIELD OF THE INVENTION

This invention relates generally to disc drive error log analysis, and, in particular, to managing the size of the disc drive error log by merging defect log entries that correspond to a series of defects on the disc running in circumferential and radial directions.

### BACKGROUND OF THE INVENTION

Disc drives are data storage devices that store digital data in magnetic form on a rotating storage medium called a disc. Modern disc drives comprise one or more rigid discs that are coated with a magnetizable medium and mounted on the hub of a spindle motor for rotation at a constant high speed. Each surface of a disc is divided into several thousand tracks that are tightly-packed concentric circles similar in layout to the annual growth rings of a tree. The tracks are typically numbered starting from zero at the track located outermost the disc and increasing for tracks located closer to the center of the disc. Each track is further broken down into sectors and servo bursts. A sector is normally the smallest individually addressable unit of information stored in a disc drive and typically holds 612 bytes of information plus additional bytes for internal drive control and error detection and correction. This organization of data allows for easy access to any part of the discs. A servo burst is a particular magnetic signature on a track, which facilitates positioning of heads over tracks.

Generally, each of the multiple discs in a disc drive has associated with it two heads (one adjacent the top surface of the disc and another adjacent the bottom) for writing and reading data to or from a sector. A typical disc drive has two or three discs. This usually means that there are four or six heads in a disc drive carried by a set of actuator arms. Data is accessed by moving the heads from the inner to outer part of the disc (and vice-versa) driven by an actuator assembly. The heads that access sectors on discs are locked together on the actuator assembly. For this reason, all the heads move in and out together and are always physically located at the same track number (e.g., it is impossible to have one head at track 0 and another at track 500). Because all the heads move together, each of the tracks on all discs is known as a cylinder for reasons that the tracks are equal-sized circles stacked one on top of the other in space forming a cylinder. So, for example, if a disc drive has four discs, it would normally have eight heads (numbered 0-7), and a cylinder number 680 would be made up of a set of eight tracks, one per disc surface, at track number 680. Thus, for most purposes, there is not much difference between tracks and cylinders since a cylinder is basically a set of all tracks whereat all the heads are currently located.

Every sector on a disc surface in a disc drive is a good sector in an ideal world; however, typical discs contain some unusable sectors on the discs when they are manufactured. It is virtually impossible to create a disc with several million sectors and not have some errors. Imperfections in the media coating on the disc or other problems may make a sector inoperable. This usually shows up as an error when attempting to read the sector. Modern disc drive control schemes use an error correction code to help identify when errors occur and in some cases to correct them. However, there will still be physical flaws that prevent parts of a disc surface from being used. These unusable sectors due to such physical flaws are called defective sectors.

When defective sectors are discovered on a disc in the disc drive, each of the sector addresses corresponding to the defective sectors is mapped to a good sector in another part of the data storage area on the disc. The defective sector addresses are stored in an error log, which occupies a portion of the data storage area on the disc. The size of the error log, which is finite, is maintained at a minimum level in order to maximize the data storage capacity of the disc drive. Thus, it is desirable to maintain the error log size that contains as many log entries as possible but occupies as little storage space on the disc as possible.

Maintaining minimal storage space for the error log is becoming increasingly difficult as the areal density of modern disc drives is increasing. A physical imperfection on a high areal density disc would produce significantly higher number of defect error log entries than a comparable physical imperfection in a disc drive with lower areal density. For example, in a high density disc drive that have 58K tracks per inch (TPI) and/or 20 gigabytes of data storage capacity per disc surface, one small radial scratch on the disc surface could be translates to hundreds or even thousands of defective sectors that are scattered over hundreds or even thousands of scratched tracks.

Accordingly, there is a need for minimizing the size of the defect error log in order to maximize the storage capacity of the disc drive.

### SUMMARY OF THE INVENTION

Against this backdrop, the present invention has been developed. The present invention essentially is a method of and a system for generating a defect error log on a disc in a disc drive by encoding any defect error log entries corresponding to defective sectors that are circumferentially and/or radially adjacent. That is, the addresses of many defective sectors that are adjacent to each other are encoded (or “merged”) into a single defect error log entry. By recording the merged defect error log entries, each representing the addresses of many defective sectors that are adjacent to each other, the disc storage space for the defect error log can be minimized.

All defective sector addresses of all defective sectors on the disc are identified. Among the defective sectors identified with addresses, there may be at least two defective sectors that are adjacent to each other circumferentially or radially or in both directions. These are identified and at least two sector addresses of adjacent defective sectors are then converted into a defect error entry, which is stored in the defect error log. A sector address of a standalone defective sector (i.e., a defective sector where an adjacent sector is not a defective sector) is also converted into another defect error entry.

When a defective sector is converted into a defect error entry, a predetermined number of adjacent sector addresses are padded and included in the defect error entry. If two defective sectors are adjacent only in circumferential direction, a predetermined number of sectors that are circumferentially adjacent the defective sector is padded. If, however, the at least two defective sectors are adjacent in a radial direction or in both circumferential and radial directions, then a predetermined number of sectors that are circumferentially adjacent the defective sector is padded, and in addition the addresses of another predetermined number of sectors are padded to the circumferentially padded sector addresses, where the predetermined number of sectors is radially adjacent the sectors of the circumferentially padded sector addresses. Both the padded sector addresses and the defective sector address are encoded into the defect error entry.

The defect error entry includes information a length of circumferentially padded sector addresses, a length of radially padded track addresses, a beginning sector address of the circumferentially padded sector addresses, and a beginning address of the radially padded track addresses.

The defect error entry stored in the defect error log can be converted back into a set of sector addresses (i.e., defective sector addresses and padded sector addresses). This reconversion is possible since the defect error entry contains information about the defective sector addresses and the padded sector addresses. A defect error entry is obtained from the defect error log on a disc. Then, all sector addresses encoded in the defect error entry are determined based on the information contained in the defect error entry. The information includes a length of circumferentially padded sector addresses, a length of radially padded track addresses, a beginning sector address of the circumferentially padded sector addresses, and a beginning address of the radially padded track addresses.

These and various other features as well as advantages that characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a simplified block diagram of a disc drive and its connection to the host computer system including a servo system with which the present invention is particularly useful.

FIG. 3 is a simplified flowchart of a disc drive manufacturing process in accordance with an embodiment of the present invention.

FIG. 4 is a simplified flowchart showing operations of a self-test certification process performed as a part of a disc drive manufacturing process in accordance with an embodiment of the present invention.

FIG. 5 illustrates sector addresses that are merged together with a single defective sector address in accordance with an embodiment of the present invention.

FIG. 6 illustrates sector addresses that are merged together with two radially adjacent defective sector addresses in accordance with an embodiment of the present invention.

FIG. 7 illustrates sector addresses that are merged together with three radially adjacent defective sector addresses in accordance with an embodiment of the present invention.

FIG. 8 is a defect error log generating flowchart in accordance with an embodiment of the present invention.

FIG. 9 is an expansion flowchart that illustrates operations for converting a defect error entry in a defect error log into sector addresses.

FIGS. 10-11 together comprise a flowchart illustrating operations for determining length of a radial scratch in accordance with an embodiment of the present invention.

### DETAILED DESCRIPTION

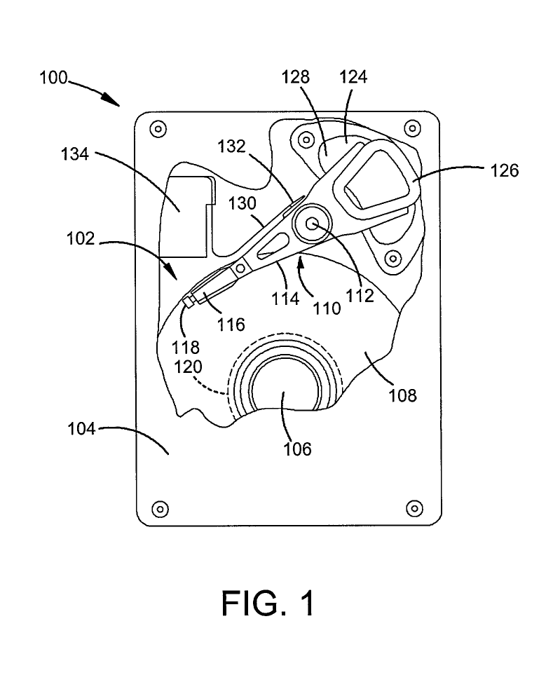

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 116 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

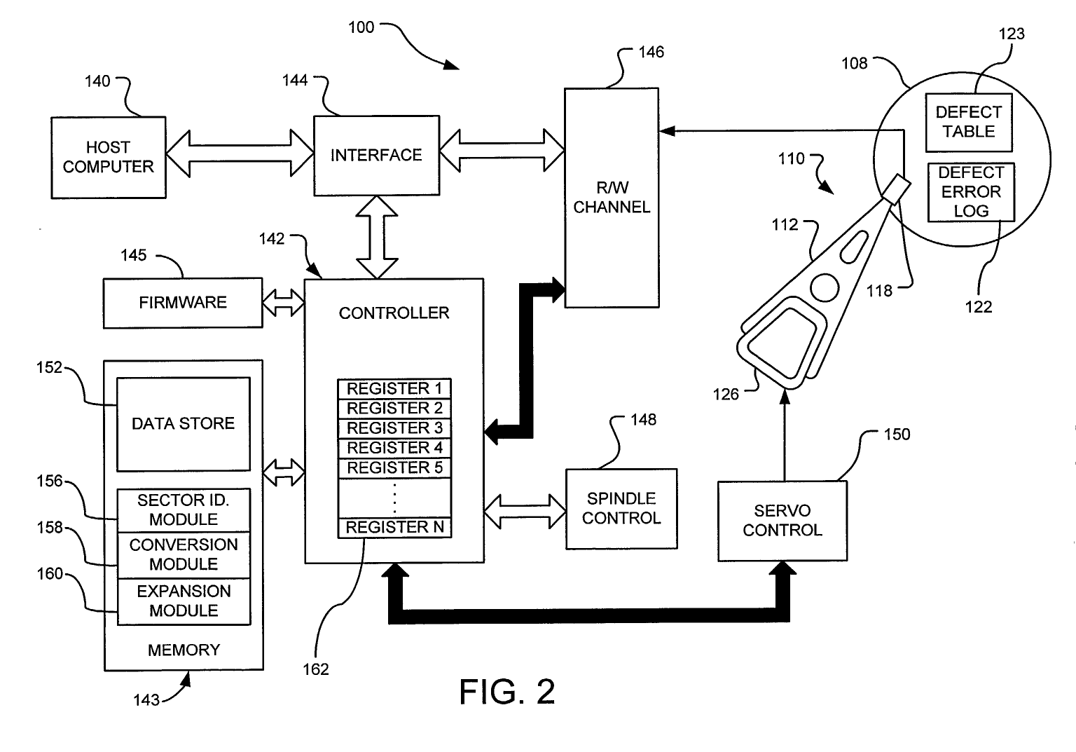

Referring now to FIG. 2, shown therein is a functional block diagram of the disc drive 100 of FIG. 1, generally showing the main functional circuits that are resident on the disc drive printed circuit board and used to control the operation of the disc drive 100. The disc drive 100 is operably connectable to a host computer 140 in which the disc drive 100 is mounted in a conventional manner. Control communication paths are provided between the host computer 140 and a disc drive controller 142. The controller 142 generally provides top level communication and control for the disc drive 100 in conjunction with programming for the controller 142 stored in a controller memory 143 and/or a firmware 145. A set of registers 162 is included in the controller 142. The register 162 is one of a small set of data holding places that are part of a controller and that provides a place for passing data from one instruction to the next sequential instruction or to another program that the controller has given control to.

The memory 143 may be a random access memory (RAM), a read only memory (ROM), or other sources of resident memory for the controller 142. The memory 143 may include programming modules (156, 158, 160) and a general data store 152 that are operably connected to the controller 142. Each programming module stores computer readable instructions that are connectable by the controller 142. The programming modules in an embodiment of the present invention include a defective sector identifying module (SECTOR ID MODULE) 156, a conversion module 158, and an expansion (or reconversion) module 160. The general data store 152 store information that is storable and readable by the controller 142.

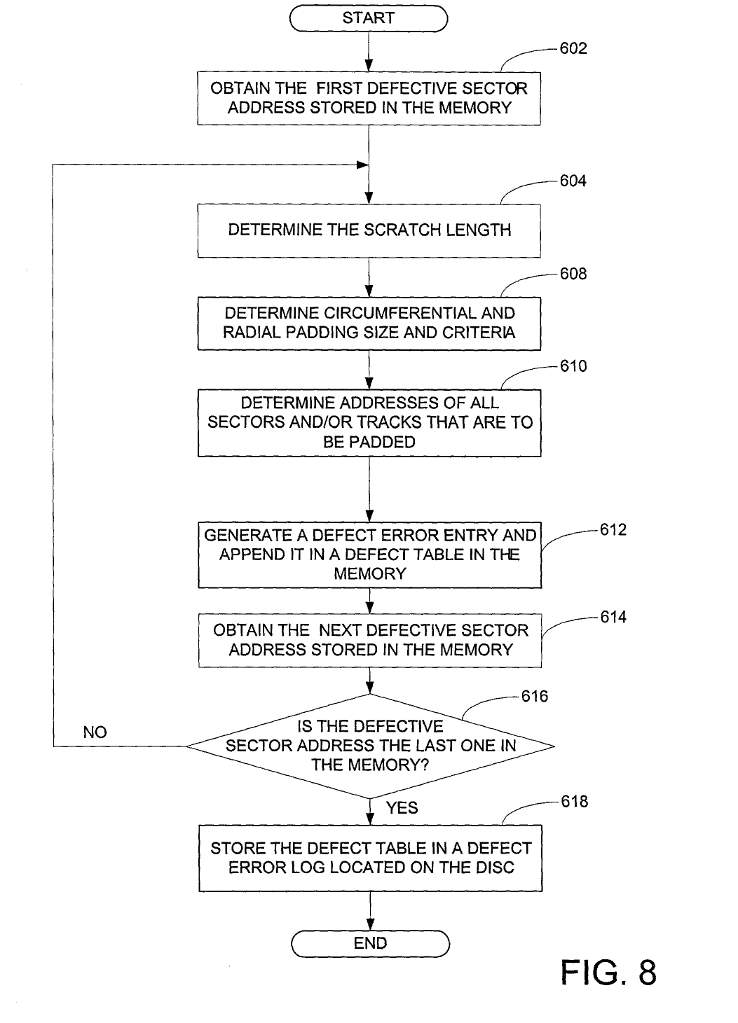

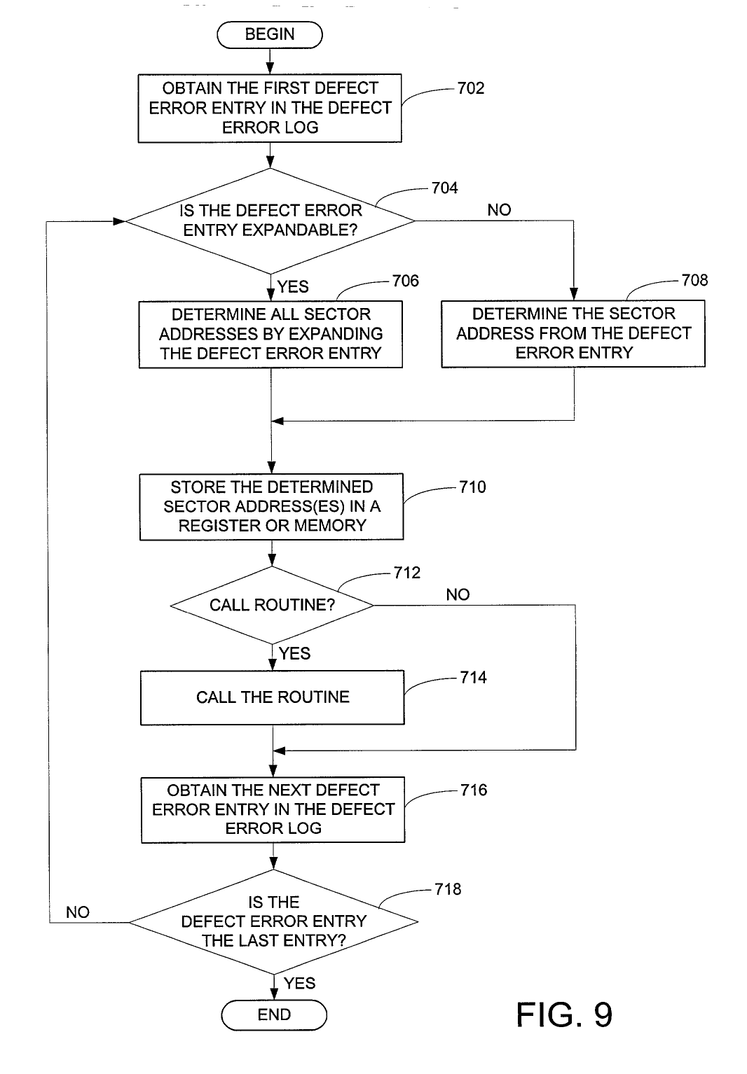

These programming modules (156, 158, 160) may be stored in the firmware 145 rather than in the memory 143. A set of programming instructions may be stored in the firmware 145 by the host computer 140 via a disc drive interface 144. Generally, the firmware 145 can be distributed like other software modules and can be created and tested by utilizing microcode simulation. The firmware 145 is often a key component of the disc drive operation, because it contains generally the software program for disc drive operations that could operate independently from the control of the host computer 140. The operations performed in accordance with an embodiment of the present invention by the programming modules (152, 156, 158) are described below with reference to FIGS. 8 and 10-11, and the operations performed in accordance with an embodiment of the present invention by the expansion module 160 are described below with reference to FIGS. 9.

Referring again to FIG. 2, the discs 108 are rotated at a constant high speed by a spindle control circuit 148, which typically electrically commutates the spindle motor 106 (FIG. 1) through the use of back electromotive force (BEMF) sensing. During a seek operation, the track position of the heads 118 is controlled through the application of current to the coil 126 of the actuator assembly 110. A servo control circuit 150 provides such control. During a seek operation, the microprocessor controller 142 receives information regarding the velocity and acceleration of the head 118 and uses that information in conjunction with a model, stored in the memory 143, to communicate with the servo control circuit 150, which will apply a controlled amount of current to the voice coil motor 126, thereby causing the actuator assembly 110 to be pivoted.

Data is transferred between the host computer 140 and the disc drive 100 by way of the disc drive interface 144, which typically includes a buffer to facilitate high speed data transfer between the host computer 140 and the disc drive 100. Data to be written to the disc drive 100 are thus passed from the host computer to the disc drive interface 144 and then to a read/write channel 146, which encodes and serializes the data and provides the requisite write current signals to the heads 118. To retrieve data that has been previously stored by the disc drive 100, read signals are generated by the heads 118 and provided to the read/write channel 146, which performs decoding and error detection and correction operations and outputs the retrieved data to the interface 144 for subsequent transfer to the host computer 140.

Generally, the disc drive interface 144 is hardware and/or software that regulates transmission of data and manages the exchange of data between the disc drive 100 and the host computer 140. This disc drive interface 144 is contained in the electronics of the disc drive 100. A standard committee such as American National Standard Institute (ANSI) oversees the adoption of an interface protocol by which any peripheral device following the common standard can be used interchangeably. Programming of the firmware 145 follows the disc drive interface protocol.

There are various types of disc drive interface standards such as Small Computer Systems Interface (SCSI), FibreChannel-Arbitrated Loop (FC-AL), Serial Storage Architecture (SSA), Advanced Technology Attachment (ATA), Integregrated Device Electronics (IDE), CompactFlash, etc. In an embodiment of the present invention, the ATA interface standard is used as an interface between the host computer 140 and the disc drive 100. However, it is well known to those skilled in the art that the same scope and spirit disclosed in an embodiment of the present invention can also be applied to other types of disc drive interfaces listed above.

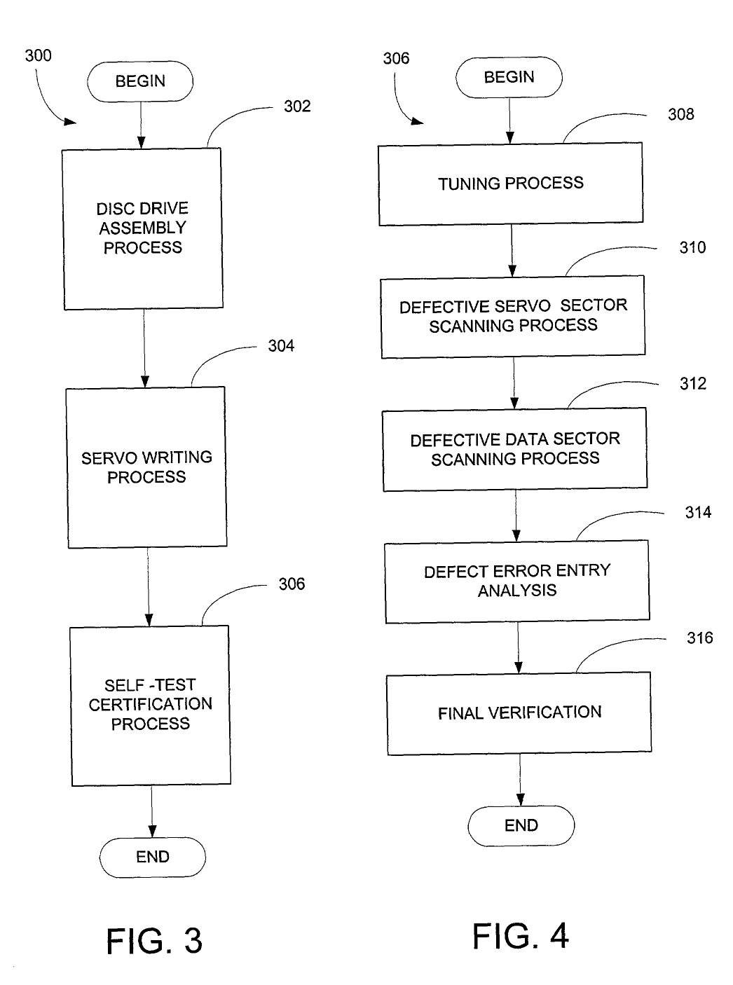

A typical disc drive 100 is manufactured in a process shown in FIG. 3. The disc drive components are first assembled in the manufacturing process in operation 302. Then the servo information that defines tracks are written on the discs 108 in the disc drive 100 in operation 304. Thereafter, the disc drive controller conducts a self-test process in operation 306, which is shown in FIG. 4, to determine whether or not the disc drive 100 is a bad drive. In the self-test certification process 306, the entire data storage area of each disc 108 is scanned to detect micro defects in sectors. The micro defects on the disc 108 are sometimes due to surface scratches running in circumferential and/or radial directions. A circumferential scratch refers to at least two adjacent defective sectors that are present on a common track. A radial scratch refers to at least two adjacent defective sectors that are present on at least two contiguous tracks. In process 306, all addresses of the identified defective sectors are processed and recorded on a defect error log 122 on the discs 108.

The self-test certification process 306 of FIG. 3 is further generally described with respect to FIG. 4. Control begins with tuning process in operation 308. The tuning process 308 is performed by calibrating the heads 118 and other electronic components in the disc drive 100 to the required disc drive specification. Control then transfers to operation 310. The disc 108 is scanned and checked to verify the correctness of the servo information written on the disc (e.g., servo bursts, zero acceleration profile coefficients, etc.). In addition, all defective servo sector addresses are identified and stored in the memory 143.

Control then transfers to operation 312. In operation 312, the entire data storage area on the disc 108 is scanned by the defective sector identifying module 156, and all identified defective data sector addresses are stored in the data store 152 in the memory 143. When a defective data sector is identified in operation 312, at least a physical cylinder head sector address (PCHS) and a physical sector address (PBA) of the defective sector are stored in the data store 152. For example, a PCHS of (323, 3, 485) means that 485^{th} sector from the index mark of a track under the head number 3 of a cylinder 323. The disc drive controller 142 uses a PCHS to access information stored in a sector on the disc 108 through the use of the actuator assembly 112. The host computer 140, however, accesses sectors on the disc 108 by their logical block addresses (LBAs), and the disc drive controller 142 has to translate the LBA into the corresponding PCHS. The disc drive controller 142 keeps tab on all sectors by assigning a PBA to each sector on the disc 108 in translating a LBA into a PCHS. That is, every sector on the disc 108 has a PCHS and a PBA, and the PBA is mapped to an LBA that is understood by the host computer 140. The disc drive controller 142 maintains the mapping scheme between an LBA and a PBA corresponding to a particular sector, and the disc drive controller 142 translates the PBA into a PCHS in order access the sector.

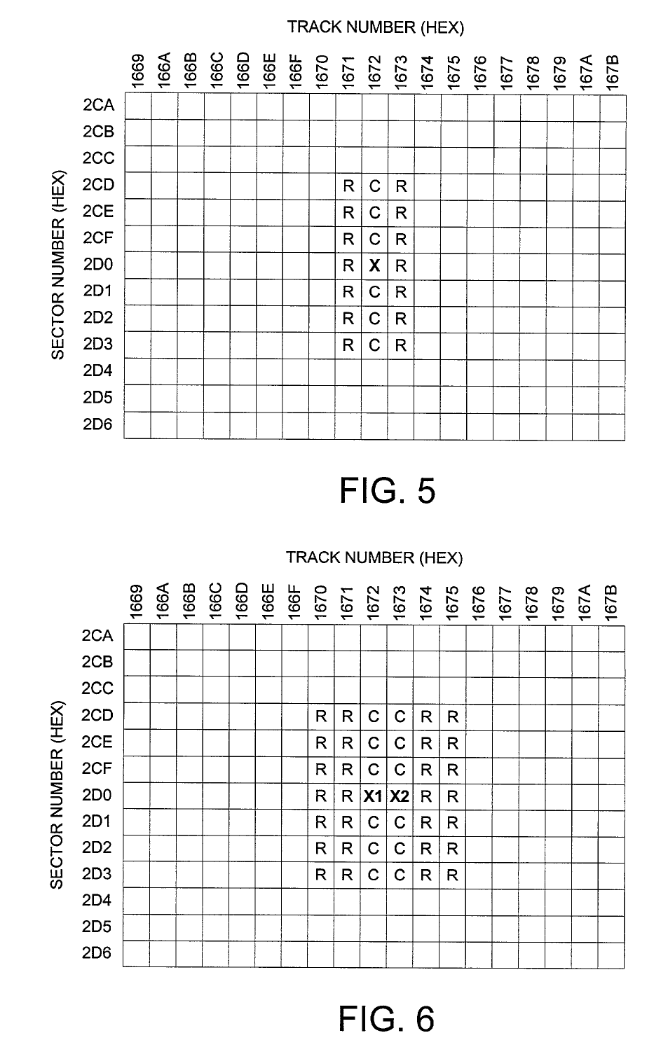

Operation 314 assumes control once all defective data sector addresses (i.e., a PCHS and a PBA for each defective sector) are identified and stored in the data store 152. Then the defective data sector addresses that are stored in the data store 152 are analyzed by the conversion module 158. According to an embodiment of the present invention, the conversion module 158 examines the defective data sector addresses stored in the data store 152 and encodes (or merges) two or more data sector addresses. For example, two or more of defective data sector addresses are merged into one defect error entry that is then stored in the defect error log 122 on the disc 108. Thus, the total number of defect error entries stored in the defect error log 122 is minimized since not every individual defective data sector address is stored as one defect error entry in the defect error log 122. The merging technique in accordance with an embodiment of the present invention that utilizes the conversion module 158 is described below with respect to FIGS. 5-9.

It is noted that the defect error log 122 utilized in an embodiment of the present invention is an independent error log that is different from an ATA error log or a SMART (Self-Monitoring, Analysis, and Reporting Technology) error log. Generally, the ATA error log records errors or any relevant information related to the operations of the ATA interface and communications between the host computer 140 and the disc drive controller 142. The SMART error log records information related to the general reliability of the disc drive 100 and may be used for failure analysis and/or failure prediction of the disc drive 100. Finally, control transfers to verification operation 316 where a final performance test is conducted to ensure that the disc drive is free from any defective sectors.

The present invention reduces the size of the defect error log 122 by encoding (or merging) data sector addresses of two or more defective sectors identified and saved in the data store 152. The merged defect error entry is then stored in the defect error log 122 on the disc 108. By maintaining the size of the defect error log 122 small, more disc surface can be utilized for data storage purposes. The defect error log 122 is capable of storing a finite number of defect error entries, and typically the defect error log 122 would easily fill up if individual defective data sector addresses there are about 100 (HEX) number of small scratches (e.g., each scratch having a length of three sectors or more). This is especially true when all three or four heads are considered since the size of the defect error log 122 is the same regardless of how many heads (i.e., disc surfaces) are utilized in the disc drive 100.

An embodiment of the present invention is directed to data sectors (i.e., identifying defective data sector addresses, merging two or more defective data sector addresses, storing the merged entry in the data error log 122, etc.) that were obtained in operation 312. However, the concept of merging addresses and storing them in a predetermined log on the disc 108 such that the size of the predetermined log is minimally maintained can be applied also to the defective servo sector addresses identified in operation 310. As described above, defective servo addresses are identified in operation 310 after the tuning process 308. The identified defective servo addresses are then stored in a servo error log (not shown) on the disc 108 and are made available to the controller such that the head 118 avoids defective servo sectors as it follows a track. For example, an entire track may be mapped out if there are more than five defective servo sectors on the track. An entire track may likewise be mapped out when the gray code in a servo sector on the track is found to be defective or missing. Such track mapping-out or skipping technique relating to defective servo sectors is not discussed as a part of an embodiment of the present invention; however, the concepts and techniques disclosed in accordance with an embodiment of the present invention can be equally applied to the defective servo sector addresses to obtain substantially similar results.

One method of minimizing the size of the defect error log 122 is known as a circumferential merging technique. According to this technique, the addresses of the circumferentially adjacent defective data sectors (stored in the data store 152) are merged into a single defect error log entry. That is, the defective data sector addresses (saved in the data store 152 in operations 312) of circumferentially adjacent defective sectors are identified and then encoded (or merged) into a new single defect error entry that is saved in the defect error log 122. This circumferential merging technique minimizes the total number of defect error entries that are to be stored in the defect error log 122. The reduced number of the defect error entries is then stored into the defect error log 122 on the disc 108. The defect error log 122 is located in a reserved zone on the disc 108.

The defect error entries that are stored in the defect error log 122 are also incorporated into a defect table 123, typically located on the system tracks normally located on the outer diameter of the disc 108. The defect table 123 contains all information relating any defective area on the disc 108, including both the defective data sector and servo sector addresses. During each disc drive power up, the information stored in the defect table 123 is loaded into the memory 143, and the controller 142 uses this information to prevent reading from or writing to the defective sectors on the disc 108.

An example of the defect error log 122 generated by utilizing the circumferential merging technique is shown with respect to TABLES 1-3. Generally, all circumferentially adjacent defective entries that are identified and stored in the data store 152 are merged into one entry, an example of which is shown in TABLE 1. Then, for the given circumferentially adjacent defective sectors, a predetermined number of good sectors are padded at the beginning and the end of the defective sectors based on the padding criteria, an example of which shown in TABLE 2. TABLE 3 shows examples of defect error entries that are circumferentially merged and padded, and these defect error entries are recorded in the defect error log 122.

TABLE 1

| Cylinder Address | Head Address | Sector Address | Circumferential |
|---|---|---|---|
| (HEX) | (HEX) | (HEX) | span count (HEX) |
| 194A | 0 | 236 | 7 |
| 0D0B | 1 | 2D9 | 8 |
| 2F05 | 2 | 160 | 7 |

Each row in TABLE 1 above represents a defect error entry before padding. A padding process is described below with respect to TABLE 2. The unpadded defect error entry in TABLE 1 consists at least of a cylinder number, a head number, a sector number, and a circumferential span count. According to the first entry in the defect error log (TABLE 1), the circumferential span count 7 on the a track identified by cylinder 194A (HEX) and head 0 (HEX) (i.e., cylinder 194A (HEX) and head 0 (HEX) together form a track) indicates that there is a total of seven defective sectors circumferentially adjacent to each other on a same track starting at the sector address 236 (HEX) and ending at the sector address 23C (HEX). The track is located at the cylinder address 194A (HEX) under the head with address 0 (HEX).

TABLE 2 is an example padding criteria for a circumferentially running scratch. From TABLE 2, it can be determined that for a circumferential scratch length of one sector or more, three sectors are padded at the beginning and at the end of the circumferentially running scratch.

TABLE 2

| Circumferential Scratch Length | Circumferential Scratch Pad Size |
|---|---|
| (HEX) | (HEX) |
| > = 1 | ±3 |

So, for example, it was determined with respect to the first entry in TABLE 1 that the circumferentially adjacent defective sectors begin at the sector address 236 (HEX) and end at the sector address 23C (HEX). Since the circumferential span count of the first entry (which is seven) is greater than one, according to TABLE 2, the three sectors before the sector address 236 (HEX) and the three sectors after the sector address 23C (HEX) are padded. Thus, a total of C (HEX) or thirteen sectors (beginning sector address 233 (HEX) and ending sector address 23E (HEX)) are merged into a single defect error entry with a span count of C (HEX). The circumferentially merged and padded defect error entries in TABLE 1 are shown in TABLE 3. Each row in TABLE 3 represents a single defect error entry.

TABLE 3

| | | Beginning Sector | Circumferential |
|---|---|---|---|
| Cylinder Address | Head Address | Address after | span count after |
| (HEX) | (HEX) | Padding (HEX) | Padding (HEX) |
| 194A | 0 | 233 | C |
| 0D0B | 1 | 2D6 | B |
| 2F05 | 2 | 15D | C |

One reason for padding circumferentially adjacent defective addresses is to prevent grown defect next to the defective sectors. Without padding, there is a possibility that existing defects may grow into the neighboring good sectors. This is because whenever the head accesses the neighboring good sectors, the head may come in contact with the rough area present on the adjacent defective sector.

If a substantial number of defective sectors are found on a track, the track may be mapped out completely (i.e., skip track) rather than merging the adjacent sectors. For example, a track in a low density disc drive with ten percent or more of defective data sectors (i.e., approximately more than 30 (HEX) number of defective data sectors) is typically mapped out.

The size of the defect error log 122 produced by the circumferential merging technique is considered to be acceptably minimal for some existing products that have low data storage capacity and/or low track density. However, for modern disc drives with high track density, a circumferential merging technique alone is insufficient to effectively maintain the minimal size of the defect error log. For example, in a high-density disc drive, one small radial scratch on the disc surface translates to hundreds or even thousands of defective sectors that are scattered over hundreds or even thousands of scratched tracks. The circumferential merging technique to record all such defective sectors in the defect error log 122 would generate a huge number of individual defect error log entries that can easily use up the predetermined storage area for the defect error log 122. This is because the defect list is generated on per sector basis based on all addresses of the defective sectors that are identified in the self-test certification process 306.

Another scheme to further reduce the number of defect error entries and thereby to reduce the size of the defect error log 122 is to merge defect error entries that correspond not only to circumferentially adjacent sectors and but also to sectors that are radially adjacent across different tracks. According to an embodiment of the present invention, defect error entries corresponding to circumferentially and/or radially adjacent defective sectors are encoded into a new single defect error entry. This technique is known as a circumferential and radial merging technique and is applied to the defective sector addresses saved in the data store 152 of the memory 143 in the operations 310 and 312. The reduced number of the defect error entries (a subset of which is made up of the circumferentially and radially merged defect error entries) is then stored into the defect error log 122 on the disc 108.

The circumferential and radial merging technique according to an embodiment of the present invention further minimizes the total number of defect error entries that are to be saved in the defect error log 122 on the disc 108. FIG. 5 shows an example of a single radial scratch (marked with “X”). In the same manner described with respect to the circumferential merging technique, the sector addresses of this defective data sector X is identified and saved in the data store 152 during operation 312.

The sector address of the defective sector X shown in FIG. 5 is then both circumferentially and radially padded. The circumferential padding is done in an identical manner as described above with respect to TABLE 2. That is, the sector address of the single defective sector X has a circumferential scratch length of one. Therefore, three adjacent sectors are to be padded at the beginning and at the end of each defect error entry according to the padding criteria shown in TABLE 2. The circumferentially padded sectors then will run from 2CD (HEX) to 2D3 (HEX) on cylinders 1672 (HEX), and this is shown in FIG. 5.

The circumferentially merged and padded sectors (i.e., sectors running from 2CD (HEX) to 2D3 (HEX)) are then radially padded according to a predefined radial padding criteria, and an example of radial merging criteria is shown in TABLE 4. As shown in TABLE 4, the number of tracks/sectors for padding depends on the radial scratch length.

TABLE 4

| Radial Scratch Length | Radial Scratch Pad Size |
|---|---|
| (HEX) | (HEX) |
| 1 | ±1 |
| 2 | ±2 |
| 3-18 | ±1F |
| 19-36 | ±28 |
| 37-54 | ±50 |
| >54 | ±59 |

Radial Scratch Length Radial Scratch Pad Size

Now referring to again FIG. 5, a single defective sector is shown with X, and it is located on the track number 1672 (HEX) (i.e., this is equivalent to the cylinder number 1672 (HEX) at a particular head number) and has the sector number 2DO (HEX). The circumferential scratch length of this defect X is one, and the radial scratch length of this defect X is also one. According to circumferential padding criteria as shown in TABLE 2±3 sectors are padded for a circumferential scratch that is one or more. Therefore, the three contiguous sectors that are circumferentially adjacent the defective sector X at the beginning and at the end are padded. These circumferentially padded sectors are shown with C in FIG. 5. That is, the three contiguous sectors (2CD (HEX), 2CE (HEX), 2CF (HEX)) are on the same track 1672 (HEX) with the defective sector X and are circumferentially adjacent the defective sector X at the beginning. Likewise, the three contiguous sectors (2D1 (HEX), 2D2 (HEX), 2D3 (HEX)) are on the same track 1672 (HEX) with the defective sector X and are circumferentially adjacent the defective sector X at the end.

Then, the sectors that are radially adjacent the defective sector X and the circumferentially padded sectors Cs are radially padded according to the radial padding criteria as shown in TABLE 4. These radially padded sectors are shown with R in FIG. 5. According to the TABLE 4, the radial pad size for the defective sector X is ±1 since the defective sector X has the radial scratch length of one. The radial pad size of ±1 indicates that the sectors that are to be radially padded come from a single track that is adjacent before and after the track that contains the defective data sector X. That is, the track number 1672 (HEX) contains the defective data sector X, and thus the radial pad sectors come from the track numbers 1671 (HEX) and 1673 (HEX).

In this manner, a total of twenty-one sectors (i.e., one defective sector X and twenty padded sectors) are merged into a single defect error entry that is then saved in the defect error log 122. TABLE 5 shows the merged defect error entry for the defective sector X and the padded sectors that are shown in FIG. 5.

TABLE 5

| CYLINDER | HEAD | SECTOR | |
|---|---|---|---|
| NUBMER | NUBMER | NUMBER | SPAN COUNT |
| 1671 (HEX) | 0 (HEX) | 2CD (HEX) | 7 × 3 (HEX) |

According to TABLE 5, a total number of 7 (HEX) sectors (i.e., span count) beginning with the sector address 2CD (HEX) (i.e., sector number) on 3 (HEX) (i.e., span count) number of tracks beginning with the cylinder address 1671 (HEX) at the head number 0 (HEX) are padded and merged into one defect error entry.

According to an embodiment of the present invention, a single defect error entry includes at least the following information fields: a cylinder number, a head number, a physical sector number, and a span count, all of which are shown above in TABLE 5. However, other information fields (e.g., a logical block address (LBA), a physical block address (PBA), etc.) that are useful for encoding and decoding defective data sector addresses and associated padded sector addresses can also be included in a defect error entry.

The same reason for padding circumferentially adjacent sector addresses (which is described above) also applies to padding radially adjacent sector addresses. That is, the radial padding of sector addresses is to prevent grown defect next to the defective sector, especially when the head traverses over the disc 108 and seeks to a sector that is adjacent the defective sector. Without padding, the existing defects may grow into the neighboring good sectors since the head may come in contact with the rough area present on the adjacent defective sector whenever the head accesses the neighboring good sector.

The size of circumferential and radial padding defined by the padding criteria shown in TABLES 2 and 4 is a matter of design choice. Pad sizes are determined based on whether the number of padded sectors are sufficient to prevent defects from growing into neighboring good sectors.

Another example of merged sectors according to the circumferential and radial merging technique of the present invention is described with respect to FIG. 6. FIG. 6 shows two radially adjacent defective sectors that are shown with X1 and X2. The defective sectors X1 and X2 have the circumferential scratch length of one and the radial scratch length of two. The circumferential pad size is then ±1, and the radial pad size is ±2 according to the padding criteria as shown in TABLES 2 and 4. Accordingly, the circumferentially padded sectors are shown with X and the radially padded sectors are shown with R in FIG. 6.

TABLE 6 shows the merged defect error entry for the defective sectors X1 and X2 and the padded sectors that are shown in FIG. 6.

TABLE 6

| CYLINDER | HEAD | SECTOR | |
|---|---|---|---|
| NUBMER | NUBMER | NUMBER | SPAN COUNT |
| 1670 (HEX) | 0 (HEX) | 2CD (HEX) | 7 × 6 (HEX) |

According to TABLE 6, a total number of 7 (HEX) sectors (i.e., span count) beginning with the sector address 2CD (HEX) (i.e., sector number) on 6 (HEX) (i.e., span count) number of tracks beginning with the cylinder address 1671 (HEX) at the head number 0 (HEX) are padded and merged into one defect error entry.

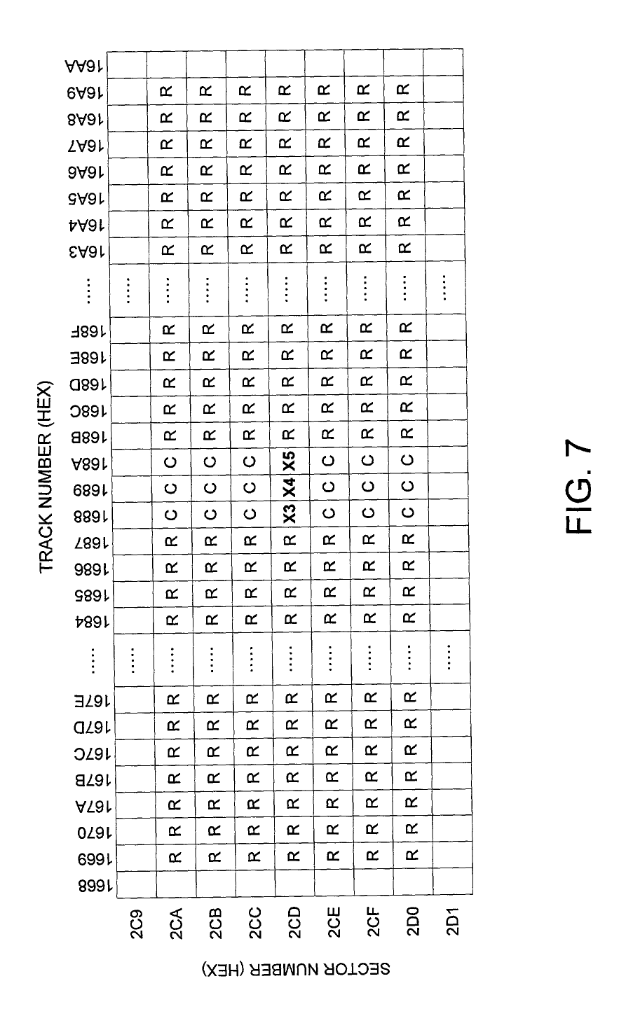

Now referring to FIG. 7, the defective sectors X3, X4, and X5 shown therein starts at the track 1688 (HEX) and ends at the track 168 A (HEX). These defective sectors have the circumferential scratch length of one and the radial scratch length of three. The circumferential pad size is therefore ±3 (HEX), and the radial pad size is ±1F (HEX) according to the padding criteria shown in TABLES 2 and 4. Accordingly, thirty-one tracks (i.e., 1F (HEX) number of tracks) are radially padded before the cylinder address 1688 (HEX) and after 168A (HEX). The result of the circumferential and radial padding is that seven circumferentially padded sectors addressed 2CA (HEX) to 2D0 (HEX) are radially padded over on sixty-five cylinders (i.e., 41 (HEX)) addressed 1669 (HEX) to 16A9 (HEX) as shown in FIG. 7.

TABLE 7 shows the merged defect error entry for the padded and defective sectors shown in FIG. 7. FIG. 7 marks the defective sectors with X1, X2, and X3 and the padded sectors with Cs and Rs. These sector addresses (i.e., sector addresses 2CA (HEX) to 2D0 (HEX) on cylinder addresses 1669 (HEX) to 16A9 (HEX)) are then encoded into one defect error entry as shown in TABLE 7. This circumferentially and radially merged defect error entry is then stored in the defect error log 122.

TABLE 7

| CYLINDER | HEAD | SECTOR | |
|---|---|---|---|
| NUBMER | NUBMER | NUMBER | SPAN COUNT |
| 1669 (HEX) | 0 (HEX) | 2CA (HEX) | 7 × 41 (HEX) |

According to TABLE 7, a total number of 7 (HEX) sectors (i.e., span count) beginning with the sector address 2CA (HEX) (i.e., sector number) on 41 (HEX) (i.e., span count) number of tracks beginning with the cylinder address 1669 (HEX) at the head number 0 (HEX) are padded and merged into one defect error entry.

Operations for performing the circumferential and radial merging technique in accordance with an embodiment of the present invention as described above are shown with respect to FIGS. 8-11. FIG. 8 is a flowchart describing each operation involved in encoding (or merging) the defective sector addresses stored in the data store 152 by utilizing the circumferential and radial merging technique in accordance with an embodiment of the present invention. The control begins in operation 602, in which operation the first defective sector address stored in data store 152 in the memory 143 is obtained. Then control transfer to operation 604 to determine scratch length of the obtained defective sector address. Both the circumferential scratch length and the radial scratch length are determined in operation 604. A non-adjacent standalone defective sector address would have the circumferential scratch length of one and the radial scratch length of one.

Whether or not a defective sector address obtained in the operation 602 is a part of a circumferential scratch is easily determined. For example, a defective sector address having a PCHS of (10, 0, 3) is a part of a circumferential scratch if there exists one or more defective sector addresses that are on the same track but have the sector number that is off by one (e.g., PCHS (10, 0, 2), PCHS (10, 0, 4), etc.). The controller 142 examines all defective sector addresses stored in the data store 143 and determines that the obtained defective sector address is a part of a circumferential scratch if a defective sector address that is adjacent the obtained defective sector address (i.e., two sector addresses share the same track number or the same cylinder number and the head number) is found.

Whether or not a defective sector address obtained in the operation 602 is a part of a radial scratch is determined by examining the defective sector addresses and finding two or more defective sector addresses that share both the same head number and the sector number as that of the obtained defective sector address but their cylinder numbers are consecutively off by one. For example, a logical sector address 133 (HEX) on cylinder 1000 (HEX) and another logical sector address 133 (HEX) on cylinder 1001 (HEX) are radially adjacent if the two sectors are on a same disc surface, i.e., same head number.

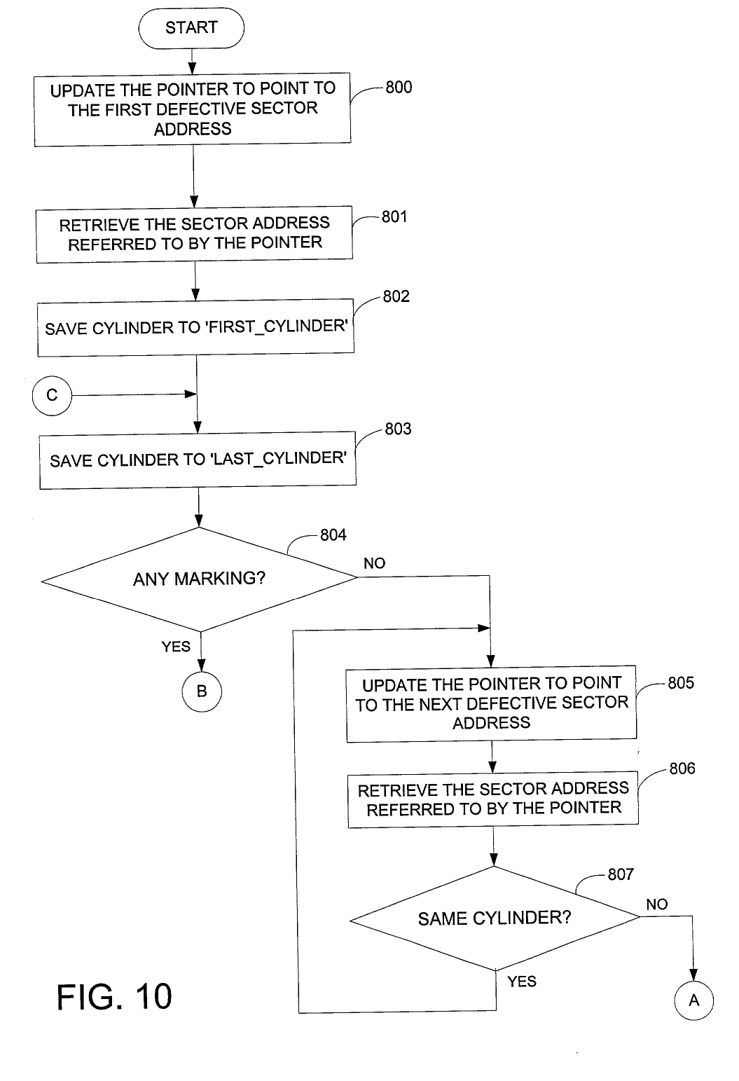

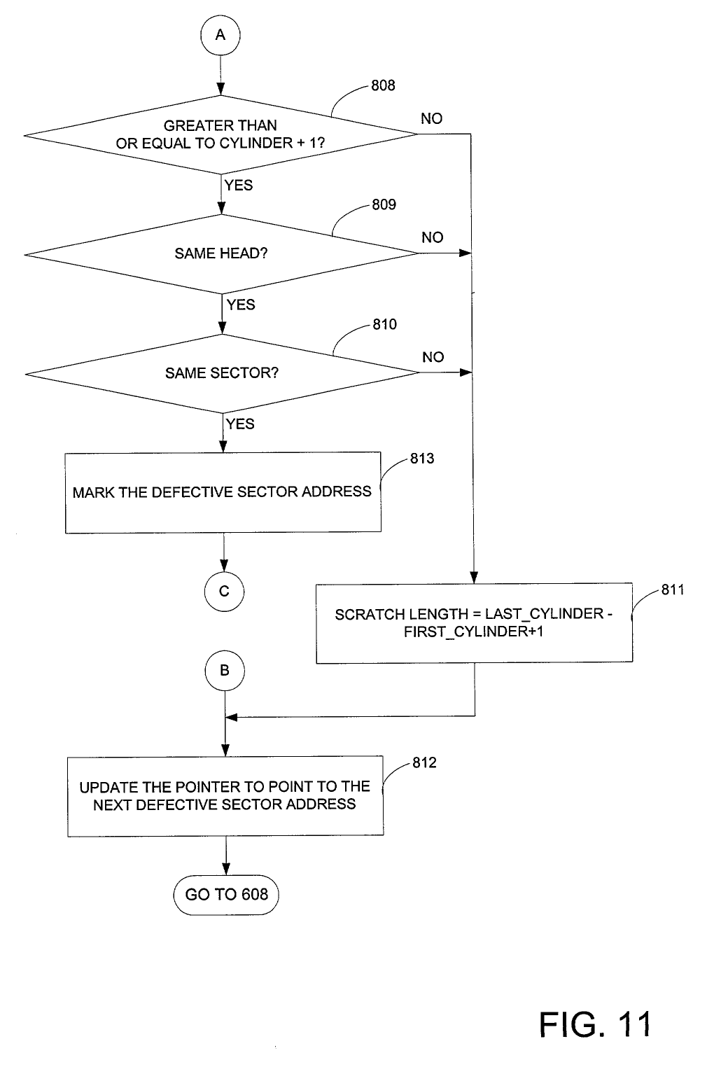

The method of determining a radial scratch length is further described with respect to FIGS. 10-11. Now referring to FIGS. 10-11, shown therein is a flowchart further illustrating the operations involved in determining a radial scratch length that are performed as a part of operation 604. The control begins in operation 800. In operation 800, a pointer that locates the first defective data sector address stored in the data store is saved. The defective data sector address includes at least a cylinder number, a head number, and a sector number of the defective sector. Control then transfers to operation 801, and the defective sector address located by the pointer is retrieved and stored in one of the registers 162. Operation 802 assumes control once the defective sector address is stored in the register, and the cylinder number of the defective sector address is stored in a portion of the memory 143 designated with a variable name “first_cylinder.” Control then transfers to operation 803, and the cylinder number of the defective sector address is stored in another portion of the memory 143 designated with a variable name “last_cylinder.”

The control then transfers to query operation 804. In this operation, the address stored in the register is checked to determine whether it is flagged with a mark. The mark denotes that the address has been already read by the controller 142 and informs the controller 142 that the address does not need to be processed again. If the address is marked in operation 804, the control branches to operation 808 in FIG. 11. If not, the control transfers to operation 805. In this operation, the pointer is updated to point to a next defective sector address stored in the data store 152. Control then transfers to operation 806, and the next defective sector address pointed to by the pointer is retrieved and stored in one of the registers 162.

Query operation 807 assumes control once the next defective sector address pointed to by the pointer is retrieved and stored in one of the registers 162. Query operation 807 checks to see if the cylinder number of the next defective sector address is equal to the cylinder number of the previous sector address. If the cylinder number is not same, then control branches to operation 808. If the cylinder number is same, then control goes back to operation 805 to get the next defective sector address. Operations 805-807 continues as long as the read sector addresses are on the same cylinder. In other words, all defect sector addresses that are read subsequent to the first defective sector address is skipped, so that none of them would be marked at this time. This is done since there may be multiple radial scratches (e.g., two or more scratches in the same cylinder but in different sectors) existing on the same cylinder.

Query operation 808 then checks to see if the cylinder number of the next defective sector address equals the cylinder number of the previous defective sector address. If the cylinder numbers equal to each other, control transfers to query operation 809. If not, control branches to operation 811.

Query operation 809 checks to see to see if the head number of the next defective sector address equals the head number of the previous defective sector address. If the two head numbers equal to each other, control transfers to query operation 810. This is to ensure that the radial scratch run on the same disc surface. If not, control branches to operation 811.

Query operation 810 checks to see if the sector number of the next defective sector address equals the sector number of the previous defective sector address. If the two sector numbers equal to each other, control transfers to query operation 813. This is to ensure that the radial scratch share the same sector number but run on several consecutive cylinder numbers. If the sector number of the next defective address is same as the sector number of the previous address, this indicates that the end of the radial scratch has not been reached. For this reason, if the two sector numbers equal to each other, control transfers to operation 813 in order to continue the operations to determine the radial scratch length. If the two sector numbers do not equal to each other, control branches to operation 811. Operation 813 then mark the current defective sector address so that the controller knows that the current defective sector address has been processed.

In operation 811, the radial scratch length is determined by subtracting the variable “first_cylinder” from the variable “last_cylinder” (i.e., radial_scratch_length=last_cylinder-first_cylinder) The radial scratch length is saved in a portion of the memory 143 designated with a variable name such as “radial_scratch_length.” The controller 142 accesses this information and knows length of the radial scratch. The control then transfers to operation 812, in which operation the pointer is updated to point to the next defective sector address in the data store 152. Then the control transfers to query operation 814. If the updated pointer points to the last defective sector address stored in the data store 152, lengths of all radial scratches are determined from the defective sector addresses stored in the data store 152, and the operation ends. If not, the control transfers to operation 801, and the radial scratch length determining operations continues.

Now referring back to FIG. 8, the control transfer to operation 608 once the lengths of the circumferential and/or the radial scratches are determined. In operation 608, the circumferential and/or radial padding size and criteria are determined in a manner described above with respect to TABLES 2 and 4. Thereafter, control transfers to operation 610, and addresses of all sectors and/or tracks for padding are determined in a manner described above with respect to TABLES 2-5 and FIGS. 3-5.

The control transfers to operation 612 from operation 610. In operation 612, a defect error entry is generated in a manner described above with respect to TABLES 5-7. The defect error entry generated in operation 612 contains encoded information of all sectors that were circumferentially and/or radially merged and padded in the previous operations 604-610.

Control then transfers to operation 614. In this operation, the generated defect error entry is appended in a defect TABLE (such as TABLE 3 and 6) in the memory 143. Control thereafter transfers to query operation 618. In this query operation, the next defective sector address and other related information stored in the memory 143 are obtained. If the obtained next defective address is not the last defective sector stored in the memory 143, the circumferential and radial merging operation repeats at the operation 604. If, however, the obtained next defective sector address is the last defective sector stored in the memory 143, the control transfers to operation 618. In operation 618, the defect table in the memory that contains all defect error entries is stored in the defect error log 122 on the disc 108.

The defect error entries in the defect error log 122 created in operations 602-618 in FIG. 8 therefore contains information about all defective and padded sector addresses of the disc drive 100. Some defect error entries are merged (or encoded) information that contains a key to multiple addresses of defective and padded sectors. As described above, the defect error entries that are stored in the defect error log 122 are then incorporated into the defect table 123 on the disc 108 typically on the system tracks that are normally located on the outer part of the disc 108. The defect table 123 contains all information relating to both defective data sectors and defective servo sectors. Therefore, the defect table 123 contains not only the information relating to defective data sectors obtained from the defect error log 122 but also the information relating to defective servo sectors obtained from the servo error log (not shown). During each disc drive power up, the information stored in the defect table 123 is loaded into the memory 143, and the controller 142 uses this information to prevent reading from or writing to the defective sectors on the disc 108. Therefore, all defect error entries in the defect error log 122 are incorporated into the defect table 123, and the defect table 123 itself is stored in the memory 143 any time the disc drive 100 is powered up.

The defect error entries that are originally from the defect error log 122 and that are now saved in the memory 143 as a part of the defect table 123 can be reconverted (or expanded) back into the original individual defective sector addresses whenever necessary. This reconversion process is known as a circumferential and radial expansion technique, and this technique is described with respect to the flowchart in FIG. 9.

Control for the circumferential and radial expansion technique begins in operation 702. In operation 702, the first defect error entry is read from the memory 143. Alternatively, the defect error log can be read directly from the defect error log 122 or the defect table 123. Control transfer to query operation 704. According to an embodiment of the present invention, the defect error entry read from the memory 143 is a merged entry that can be decoded to one or more defective data sector addresses and the multiple padded sector addresses that are associated with the defective sector addresses as described with respect to TABLES 5-7. However, a single unmerged data sector address could be included in the defect table 123 so that that data sector is reserved as a spare sector or for purposes other than ordinary data storage retrieval. Such a data sector address does not need to be expanded since no additional sector addresses are merged with that data sector address. In query operation 704, whether or not the read defect error entry is a merged entry is determined. If the defect error entry read from the defect error log 122 is a merged entry, then control transfers to operation 706. If, however, the defect error entry read from the defect error log 122 is not a merged entry, then the control transfers to operation 708.

In operation 706, the defect error entry is expanded to individual addresses that are either defective or padded sector addresses based on the information contained in the defect error entry such that shown in TABLES 5-7. As described above, a merged defect error entry according to an embodiment of the present invention include at least the following information fields: a cylinder number, a head number, a physical sector number, and a span count as shown with respect to TABLES 5-7. The cylinder number and the head number in a defect error entry together indicate the beginning track number on which padded sectors are located. The physical sector number in the defect error entry indicates the beginning sector number on the beginning track number. The span count of the defect error entry indicates the total number of sectors that are merged into the defect error entry by providing the total number of adjacent sectors that are subsequent to the beginning sector number and the total number of adjacent tracks that are subsequent to the beginning track.

Operation 706 decodes the information fields of the defect error entry in the manner described above and generates individual physical cylinder, head, sector address (PCHS) for each sector that was merged into the defect error entry. The individual addresses, for example, would refer to individual addresses denoted with R, C, and X in FIGS. 5-7. More specifically, with the starting cylinder number, the head number, and the sector number known from a defect error entry, the padded area can be easily calculated with the help of width and height information of the padded sector area, which is stored in the span count (i.e., the width refers to the radial length and the height refers to the circumferential length). Then, two counters can be used to expand the defect error entry into individual sector addresses. One counter operates based on the width (i.e., the radial length), and the other counter operates based on the height (i.e., the circumferential length). The operation of these two counters in conjunction with the starting cylinder number, the starting head number, and the starting sector number, the defect error entry is expanded to individual sector addresses.

In operation 708, the sector address information related to the unmerged defect error entry is determined when query operation 704 has determined that the defect error entry is determined to be not expandable. Control then transfers to operation 710. In this operation, all sector addresses obtained from the operations 706 and 708 are stored in the registers or the memory 143. These sector addresses stored in the registers 162 or the memory 143 are then available to be used by other programming routines or modules that need the sector address information. Therefore, the reconversion operations shown in FIG. 9 can be called by other programming routines or modules whenever the routines or modules require the sector address information encoded in a defect error entry in the defect error log 122.

Control transfers to query operation 712. If there is a programming routine that requires the sector address information stored in the registers 162 or the memory 143 (this is determined in operation 710), control transfer to operation 714. If no programming routine requires the sector address information stored in the registers or the memory 143, control transfer to operation 716. In operation 714, the programming routine is called, and the sector address information and other related information is passed to the programming routine. The programming routine called in operation 714 may be a different programming module that called the reconversion operations 702-718 in FIG. 7; however, the information may be passed to the same programming routine that the reconversion operations 702-718 in FIG. 7. In operation 716, the next defect error entry in the defect error log is obtained from the memory 143. Control then transfers to query operation 718. In this query operation, whether the obtained next defect error entry is the last defect error entry in the defect error log 122. If the obtained defect error entry is not the last entry in the defect error log, the control transfers to opertion 704 to continue with the expansion or reconversion process. If, however, the obtained defect error entry is the last entry in the defect error log, the expansion or reconversion process ends.

In summary, the present invention may be viewed as a method of, a system for, and computer readable media for generating a defect error log (such as 122) on a disc (such as 108) in a disc drive (such as 100). Defective sector addresses of all defective sectors on the disc are identified (such as in operations 306, 310, 312, and 314) by a defective sector identifying module (such as 149) that is either a part of the controller (such as 142) or operably connected to the controller (such as 156). Among the identified defective sector addresses, at least two defective sector addresses are of sectors that are adjacent to each other in circumferential or radial direction or in both directions (such as shown in FIG. 5-7). Then at least two sector addresses of adjacent defective sectors are converted into a defect error entry (such as in operations 604, 608, 610, 612, and 616 and in TABLES 3 and 6). The defect error entry is then stored in the defect error log (such as in operation 618).

A sector address of a standalone defective sector is converted to another defect error entry (such as in operations 604, 612, 614, and 616). In converting a standalone defective sector to a defect error entry, a predetermined number of sector addresses of the sectors that are circumferentially adjacent the defective sector are circumferentially padded to the defective sector address (such as in operations 608 and 610 and in TABLES 2 and 4). Both the padded sector addresses and the defective sector address are converted into the defect error entry (such as in operation 612).

A sector address of a circumferentially and radially adjacent defect sectors are also converted into a defect error entry (such as in operations 604, 608, 610, 612, and 616 and in TABLE 3 and 5). In this conversion process, addresses of a predetermined number of sectors are circumferentially padded to the defective sector address (such as in operation 608 and 610 and in TABLE 3). The padded predetermined number of sectors is circumferentially adjacent the defective sector (such as in TABLES 1 and 2). Then, addresses of another predetermined number of sectors are radially padded to the circumferentially padded sector addresses (such as in operations 608 and 610 and in TABLE 6). The predetermined number of sectors is radially adjacent the sectors of the circumferentially padded sector addresses such that both the padded sector addresses and the defective sector address are encoded into the defect error entry (such as in operations 612, 614, and 616).

The defect error entry includes information about at least a length of circumferentially padded sector addresses, a length of radially padded track addresses, a beginning sector address of the circumferentially padded sector addresses, and a beginning address of the radially padded track addresses (such as in TABLES 5-7 and in FIGS. 5-7).

In addition, the present invention may be viewed as a method of and computer readable media for generating sector addresses from a defect error entry stored in a defect error log (such as 122) on a disc (such as 108) in a disc drive (such as 100). The defect error entry contains information about a defective sector address and padded sector addresses (such as in TABLES 3 and 6). A defect error entry in the defect error log is obtained (such as in operation 702). Then, all sector addresses encoded in the defect error entry is determined based on the information contained in the defect error entry (such as in 10 operations 706 and 708). The information includes at least a length of circumferentially padded sector addresses, a length of radially padded track addresses, a beginning sector address of the circumferentially padded sector addresses, and a beginning address of the radially padded track addresses (such as in TABLES 5-7).

It will be clear that the present invention is well adapted to attain the ends and advantages mentioned as well as those inherent therein. While a presently preferred embodiment has been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

What is claimed is:

1. A method of generating a defect error log for a disc drive comprising steps of:
(a) identifying defective sector addresses of defective sectors on the disc, wherein at least two defective sectors are adjacent to each other in a circumferential direction or in a radial direction or in both directions;
(b) converting the sector addresses of adjacent defective sectors into a single defect error entry; and
(c) storing the defect error entry in the defect error log.

2. The method of claim 1 further comprising:
(d) converting a sector address of a standalone defective sector into another defect error entry.

3. The method of claim 1, wherein the converting step (b) comprises:
(b)(i) circumferentially padding addresses of a predetermined number of sectors to the defective sector address, wherein the predetermined number of sectors is circumferentially adjacent the defective sector;
(b)(ii) radially padding addresses of another predetermined number of sectors to the circumferentially padded sector addresses, wherein the predetermined number of sectors is radially adjacent the sectors of the circumferentially padded sector addresses such that both the padded sector addresses and the defective sector address are encoded into the defect error entry.

4. The method of claim 3, wherein the defect error entry includes information about at least a length of circumferentially padded sector addresses, a length of radially padded track addresses, a beginning sector address of the circumferentially padded sector addresses, and a beginning address of the radially padded track addresses.

5. The method of claim 2, wherein the converting step (d) comprises:
(d)(i) circumferentially padding a predetermined number of sector addresses of the sectors that are circumferentially adjacent the defective sector to the defective sector address, wherein both the padded sector addresses and the defective sector address are converted into the defect error entry.

6. The method of claim 5, wherein the defect error entry includes information about at least a length of circumferentially padded sector addresses, a length of radially padded track addresses, a beginning sector address of the circumferentially padded sector addresses, and a beginning address of the radially padded track addresses.

7. A computer-readable media readable by a computer and encoding instructions for executing the method recited in claim 1.

8. A method of generating sector addresses from a defect error entry stored in a defect error log on a disc in a disc drive, the defect error entry containing information about a defective sector address and padded sector addresses, the method comprising:
(a) obtaining a defect error entry in the defect error log; and
(b) determining all sector addresses encoded in the defect error entry based on the information contained in the defect error entry wherein the information includes at least a length of circumferentially padded sector addresses, a length of radially padded track addresses, a beginning sector address of the circumferentially padded sector addresses, and a beginning address of the radially padded track addresses.

9. A computer-readable media readable by a computer and encoding instructions for executing the method recited in claim 8.

10. A system for generating a defect error log on a disc in a disc drive comprising:
a disc drive controller;
a defective sector address identifying module, operably connected to the controller, that identifies all defective sectors on the disc, wherein at least two defective sectors are adjacent to each other circumferentially or radially or in both directions; and
an conversion module, operably connected to the controller, that converts at least two sector addresses of adjacent defective sectors into a defect error entry and stores the defect error entry in the defect error log.

11. The system according to claim 10, wherein the conversion module further converts a sector address of a standalone defective sector into another defect error entry.

12. The system of claim 10, wherein the conversion module circumferentially pads addresses of a predetermined number of sectors to the defective sector address, wherein the predetermined number of sectors is circumferentially adjacent the defective sector.

13. The system of claim 12, wherein the conversion module radially pads addresses of another predetermined number of sectors to the circumferentially padded sector addresses, wherein the predetermined number of sectors is radially adjacent the sectors of the circumferentially padded sector addresses such that both the padded sector addresses and the defective sector address are encoded into the defect error entry.

14. The method of claim 13, wherein the defect error entry includes information about at least a length of circumferentially padded sector addresses, a length of radially padded track addresses, a beginning sector address of the circumferentially padded sector addresses, and a beginning address of the radially padded track addresses.

15. The method of claim 11, wherein the conversion module circumferentially pads a predetermined number of sector addresses of the sectors that are circumferentially adjacent the defective sector to the defective sector address, wherein both the padded sector addresses and the defective sector address are converted into the defect error entry.

16. The method of claim 15, wherein the defect error entry includes information about at least a length of circumferentially padded sector addresses, a length of radially padded track addresses, a beginning sector address of the circumferentially padded sector addresses, and a beginning address of the radially padded track addresses.

17. A system for generating sector addresses from a defect error entry stored in a defect error log on a disc in a disc drive, wherein the defect error entry contains information about a defective sector address and padded sector addresses, the system comprising:
a disc drive controller; and
an expansion module, operably connected to the controller, that obtains a defect error entry in the defect error log and that determines all sector addresses encoded in the defect error entry based on the information contained in the defect error entry wherein the information includes one or more of a length of a circumferentially padded sector address, a length of a radially padded track address, a beginning sector address of the circumferentially padded sector address, and a beginning address of the radially padded track address.

18. A system for generating a defect error log on a disc in a disc drive comprising:
a disc drive controller; and
means for converting at least two sector addresses of adjacent defective sectors into a defect error entry and stores the defect error entry in the defect error log.

19. The system of claim 18 further comprising:
means for identifying all defective sectors on the disc, wherein at least two defective sectors are adjacent to each other circumferentially or radially or in both directions.

20. The system according to claim 19, wherein the means for converting further converts a sector address of a standalone defective sector into another defect error entry.

21. The system of claim 19, wherein the means for converting circumferentially pads addresses of a predetermined number of sectors to the defective sector address, wherein the predetermined number of sectors is circumferentially adjacent the defective sector.

22. The system of claim 21, wherein the means for converting radially pads addresses of another predetermined number of sectors to the circumferentially padded sector addresses, wherein the predetermined number of sectors is radially adjacent the sectors of the circumferentially padded sector addresses such that both the padded sector addresses and the defective sector address are encoded into the defect error entry.

23. The method of claim 22, wherein the defect error entry includes information about at least a length of circumferentially padded sector addresses, a length of radially padded track addresses, a beginning sector address of the circumferentially padded sector addresses, and a beginning address of the radially padded track addresses.
